(19) United States
(12) Patent Application Publication
(10) Pub. No.: US 2008/0217372 A1
(43) Pub. Date: Sep. 11, 2008

(54) Fastener Driving Tool

(75) Inventor: Roger Clyde Webb, Tasmania (AU)

Correspondence Address: D. PETER HOCHBERG CO. L.P.A., 1940 EAST 6TH STREET, CLEVELAND, OH, 44114, US

(73) Assignee: POLY SYSTEMS PTY LTD, TASMANIA (AU)

(21) Appl. No.: 10/584,961

(22) PCT Filed: Dec. 30, 2004
(86) PCT No.: PCT/AU04/01836

§ 371 Date: Jun. 14, 2007

(30) Foreign Application Priority Data
Dec. 30, 2003 (AU) 2003907160
Feb. 4, 2004 (AU) 2004900539

(51) Int. Cl. B25C 1/08; B25C 1/14; F02B 71/00

(52) U.S. Cl. 227/10; 227/131; 123/292

(57) ABSTRACT

A fastener driving tool comprising a tool nose through which a fastener is fired and a loading apparatus for introducing the fastener into the tool nose. The fastener is propelled by a gas combustion mechanism comprising a first priming cylinder having a first piston and an air intake fluidically connected via a first valve apparatus to a second delivery cylinder having a second piston. The first priming cylinder is fluidically connected to a fuel gas reservoir via a second valve apparatus. The first priming cylinder receives fuel from the reservoir and air through the air intake to form an air/fuel gas mixture therein. The first piston compresses the air/fuel gas mixture and transfers the air/fuel gas mixture to the second delivery cylinder via the first valve apparatus. The air/fuel mixture is ignited therein and urges the second piston towards the fastener and propels the fastener away from the tool nose.

### CROSS-REFERENCE TO RELATED APPLICATIONS

This application is a National Stage application of International Application No. PCT/AU2004/001836, filed on Dec. 30, 2004, which claims priority of Australian application number 2003907160, filed on Dec. 30, 2003 and Australian application number 2004900539, filed on Feb. 4, 2004.

### BACKGROUND OF THE INVENTION

### Field of the Invention

The present invention relates to an internal combustion fastener driving tool.

Fastener driving tools have been developed that use internal combustion as a power source to drive fasteners, such as nails, into a work piece or substrate. The tools ignite a fuel/air mixture in a combustion chamber to forcibly drive a piston, which then ejects the fastener from the tool. The effectiveness of the prior art tools is largely limited by their efficiency in rapidly igniting the complete volume of fuel/air mixture. If insufficient volumes of fuel ignite, the device delivers unsuitable driving forces to the fastener. If the tool produces unreliable power outputs, the fasteners may be driven to unsatisfactory depths or insufficiently seated. Prior art devices in the past have attempted to address these inefficiencies by making a larger tool and wasting larger volumes of fuel.

One such prior art device is described in U.S. Pat. No. 5,213,247 (Gschwend et al). This device describes a network of mechanisms that operate to measure a specific quantity of fuel and then draw that fuel, along with air, into a combustion chamber by mechanically expanding the combustion chamber volume. A drawback of this device is that the fuel and gas are not mixed sufficiently, which decreases the efficiency of combustion. Secondly, the device draws fuel and air into the combustion chamber with a partial vacuum. As a consequence, the fuel/air mixture is ignited at a low pressure, which leads to a low burn rate and further inefficiency. This is particularly problematic in that the less efficient an internal combustion fastener driving tool is, the more susceptible the device is to output fluctuations that result in ignition failures and unsatisfactory driving forces to the fastener.

The present invention seeks to provide a fastener driving tool that will ameliorate or overcome at least one of the deficiencies of the prior art.

### SUMMARY OF INVENTION

In a first aspect the present invention consists in a fastener driving tool comprising: a tool nose through which a fastener is fired; loading means for introducing said fastener into said tool nose; said fastener being adapted to be propelled by a gas combustion mechanism, wherein said gas combustion mechanism comprises a first priming cylinder having a first piston and an air intake fluidically connected via a first valve means to a second delivery cylinder having a second piston, said first priming cylinder fluidically connected to a fuel gas reservoir via a second valve means, said first priming cylinder adapted to receive fuel gas from said fuel gas reservoir and air through said air intake thereby forming an air/fuel gas mixture therein, said first piston adapted to compress said air/fuel gas mixture and transfer said air/fuel gas mixture to said second delivery cylinder via said first valve means, said air/fuel mixture ignited therein and thereby urging said second piston towards said fastener and propelling the same away from said tool nose.

Preferably in a first embodiment said first piston is mechanically actuated. Preferably said second valve means is opened and closed via mechanical actuation.

Preferably in a second embodiment said first piston is electromagnetically actuated. Preferably said second valve means is opened and closed via electromagnetic actuation.

Preferably said fastener driving tool is a nail gun.

Preferably in a third embodiment a mechanism movable between a first and a second position along said tool nose includes a latching means for engaging said second position, such that said air/fuel gas mixture is further compressed by said second piston as said mechanism is moved from said first to said second position with said latching means engaged and wherein the downward force from the ignition of said air/fuel mixture overcomes said latching means and urges said second piston towards said fastener.

Preferably a bumper is disposed near the bottom of said second delivery cylinder, such bumper adapted to be compressed by said second piston in the bottom of its travel and wherein the subsequent restoration of said bumper is further adapted to forcibly return said second piston back up said second delivery cylinder.

Preferably the interior of said bumper forms a chamber adapted to port pressurised air via an outlet valve through a transfer channel to said first priming cylinder as said bumper is compressed.

Preferably said first piston has an internal receiver for storing said pressurised air.

Preferably a sealing ring having a semi-flexible lip is disposed around the periphery of said second piston.

Preferably a mixing fan is rotatably mounted to the interior of said second delivery cylinder.

Preferably an externally mounted motor drives said mixing fan via magnetic coupling.

Preferably said second delivery cylinder is exhausted via a plate valve that fluidly connects said second delivery cylinder with an exhaust plenum when said plate valve is opened.

Preferably in a second aspect the present invention consists in an apparatus utilising a gas combustion mechanism for propulsion of an object, said gas combustion mechanism comprises a first priming cylinder having a first piston and an air intake fluidically connected via a first valve means to a second delivery cylinder having a second piston, said first priming cylinder fluidically connected to a fuel gas reservoir via a second valve means, said first priming cylinder adapted to receive fuel gas from said fuel gas reservoir and air through said air intake thereby forming an air/fuel gas mixture therein, said first piston adapted to compress said air/fuel gas mixture and transfer said air/fuel gas mixture to said second delivery cylinder via said first valve means, said air/fuel mixture ignited therein and thereby urging said second piston towards said object thereby propelling the same.

### BRIEF DESCRIPTION OF THE DRAWINGS

FIG. 1 is a perspective schematic view of a first embodiment of a nail gun in accordance with the fastener driving tool of the present invention.

FIG. 2 is a cross-sectional schematic view of the nail gun of FIG. 1.

FIG. 3 is a cut away end view of the nail gun of FIG. 1.

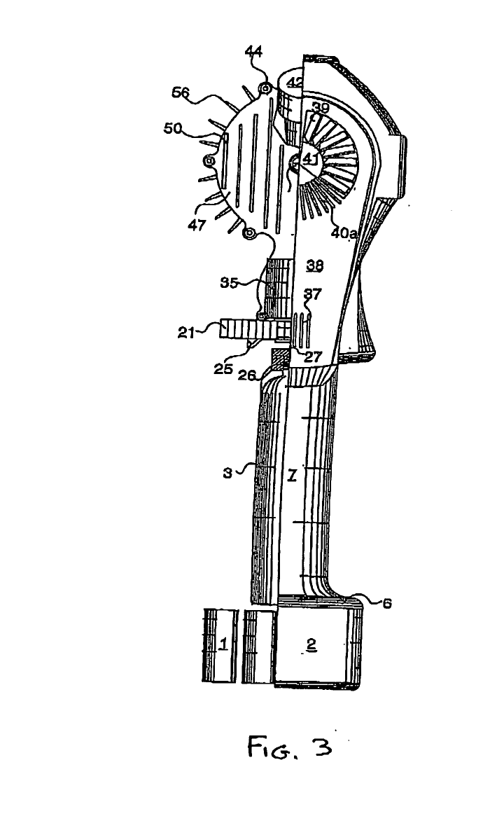

FIG. 4 is an enlarged view of the gas combustion mechanism shown in FIG. 2.

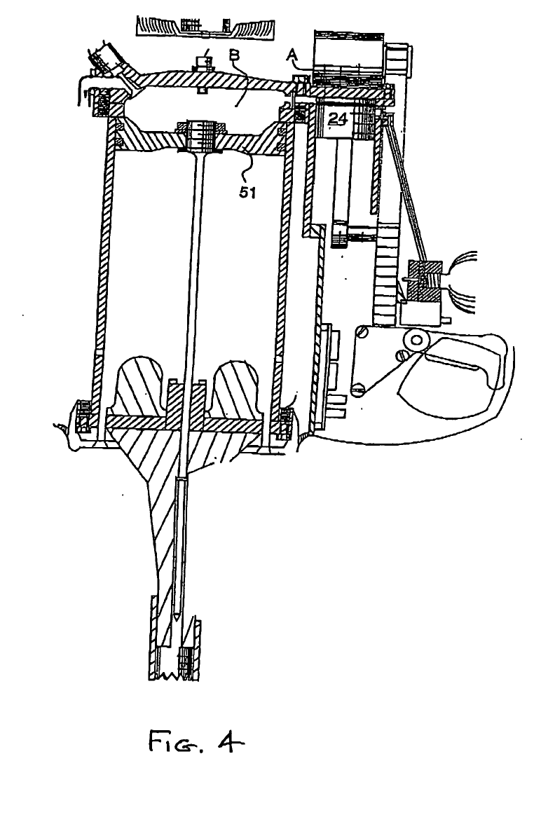

FIG. 5 is an enlarged view of the gas combustion mechanism shown in FIG. 2, as air and fuel enter the priming cylinder.

FIG. 6 is an enlarged view of the gas combustion mechanism shown in FIG. 2, as air/fuel mixture is compressed in the priming cylinder.

FIG. 7 is an enlarged view of the gas combustion mechanism shown in FIG. 2, as air/fuel mixture is transferred from the priming cylinder to the driving cylinder.

FIG. 8 is an enlarged view of the gas combustion mechanism shown in FIG. 2, as air/fuel mixture within the driving cylinder is compressed.

FIG. 9 is an enlarged view of the gas combustion mechanism shown in FIG. 2, as the ignited air/fuel mixture displaces the piston within the driving cylinder towards the nail to be fired.

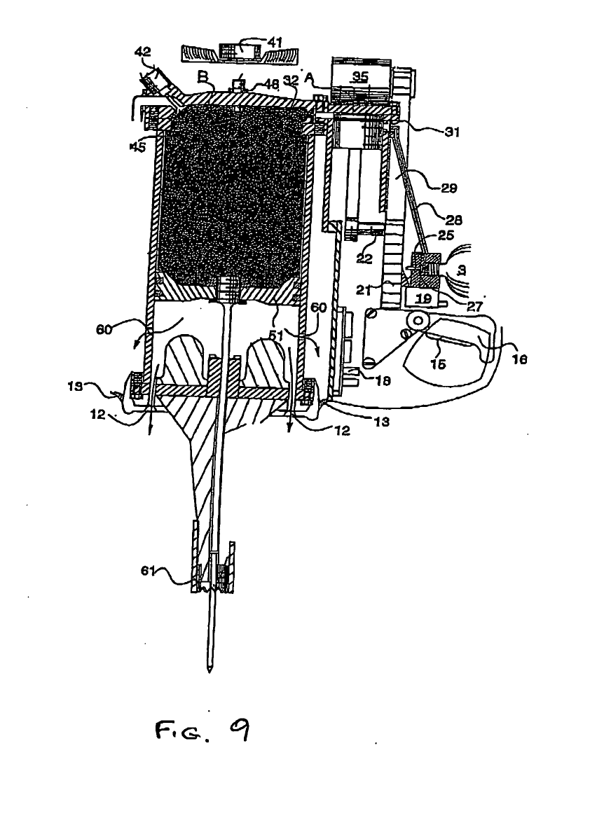

FIG. 10 is an enlarged view of the gas combustion mechanism shown in FIG. 2, as the driver connected to the piston propels the nail and the gas begins to be exhausted from the driving cylinder.

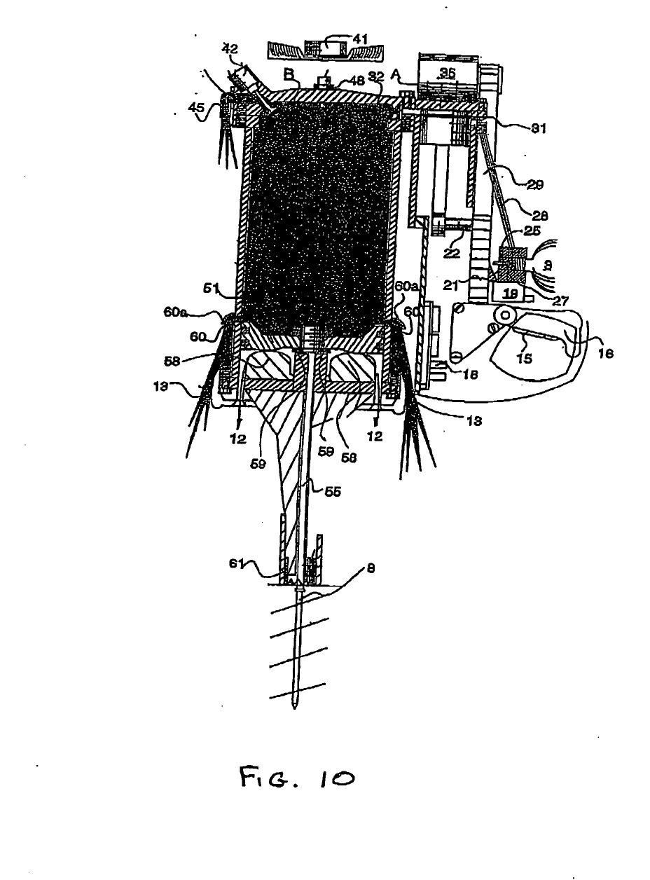

FIGS. 11 and 12 are enlarged views of the gas combustion mechanism shown in FIG. 2, as piston is returned back up the driving cylinder and remaining exhaust gas is purged from the driving cylinder.

FIG. 13 is an enlarged view of the cycle wheel arrangement used to control the tool cycle.

FIG. 14 is an enlarged view of an alternative embodiment of the cycle wheel arrangement shown in FIG. 13.

FIGS. 15a and 15b are enlarged elevation and cutaway views of the fuel gas cartridges.

FIG. 16 is a cross-sectional schematic view of a second embodiment of a nail gun in accordance with the fastener driving tool of the present invention.

FIG. 17 is a schematic view of a third embodiment of a nail gun in accordance with the fastener driving tool of the present invention.

FIG. 18 is an enlarged schematic view of the internal receiver of the nail gun depicted in FIG. 17.

FIG. 19 is an enlarged cutaway partial view of the sealing ring of the nail gun depicted in FIG. 17.

FIG. 20 is an enlarged schematic view of the plate valve of FIG. 17.

### DETAILED DESCRIPTION OF THE PREFERRED EMBODIMENT

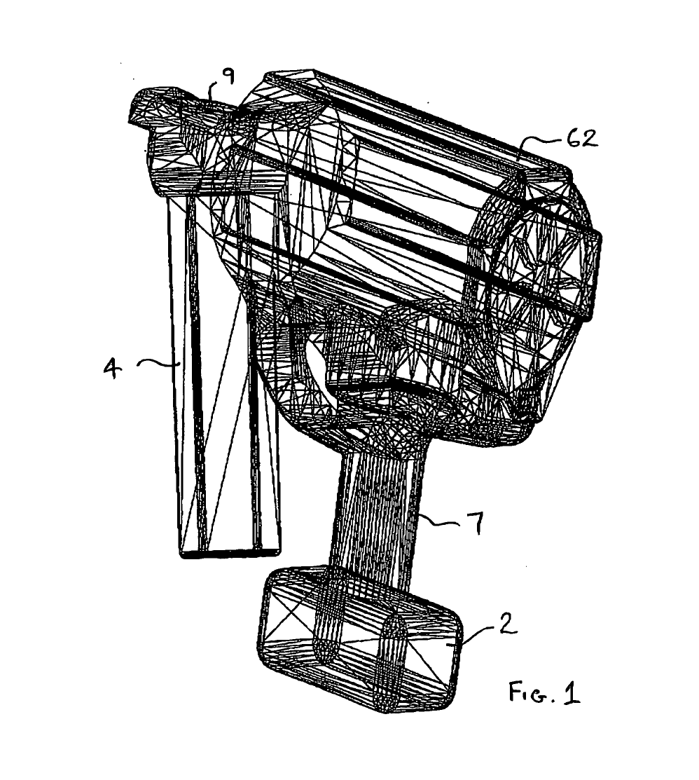

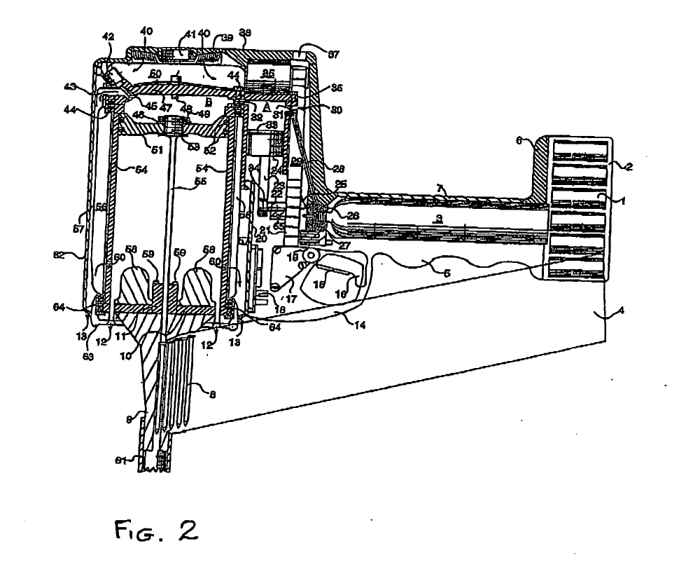

FIGS. 1 and 2 depict a combustion driven nail gun (tool) for firing nail fasteners. The nail gun comprises a priming cylinder A and a power driving cylinder B, housed within tool main body casing 62. A tool support handle 7 having a pistol grip 5 extends from casing 62 and houses a fuel gas cartridge (reservoir) 3. A battery 1 housed within removable battery casing 2 is attached to support handle 7. A nail fastener cartridge (or magazine) 4 delivers nail fasteners 8 to tool nose (or barrel) 9.

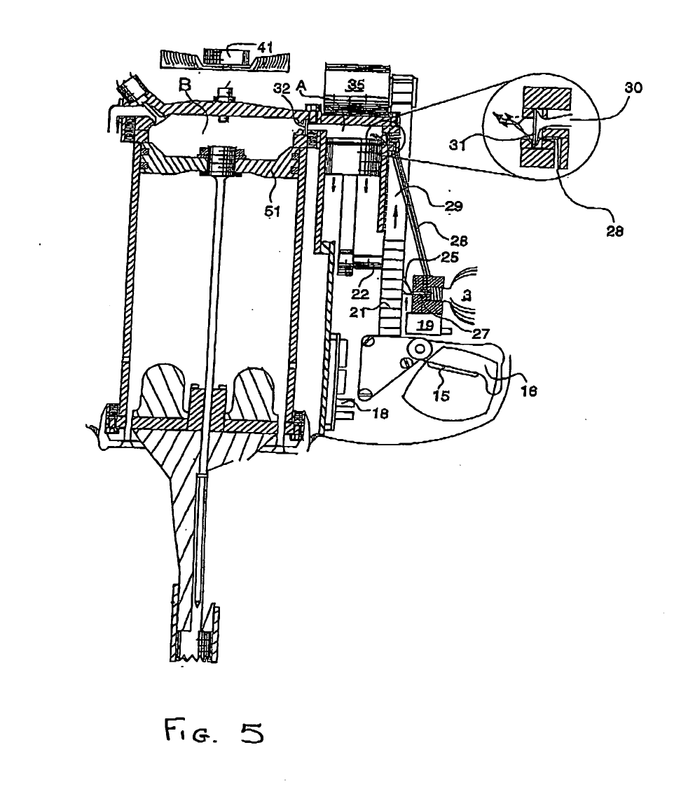

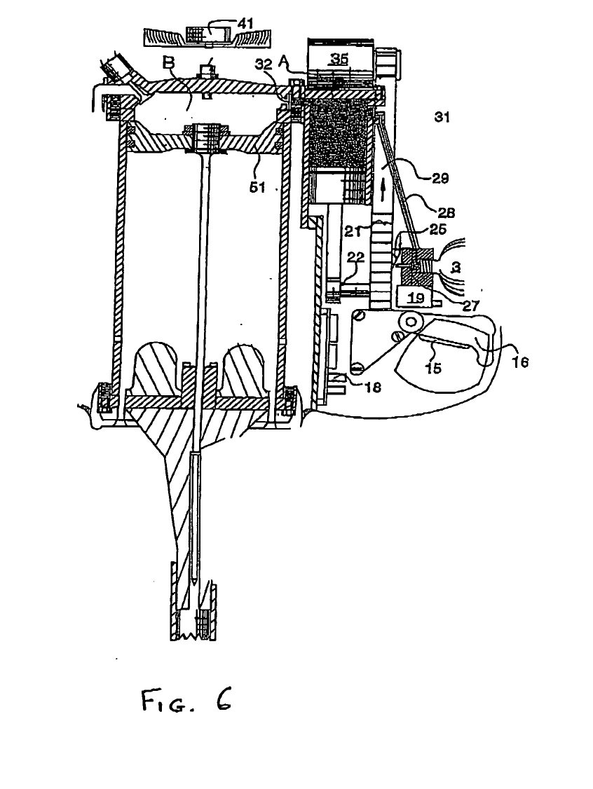

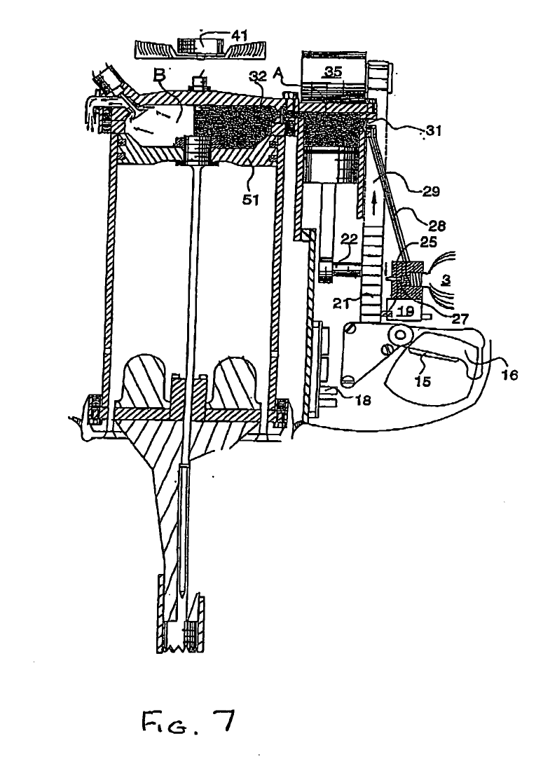

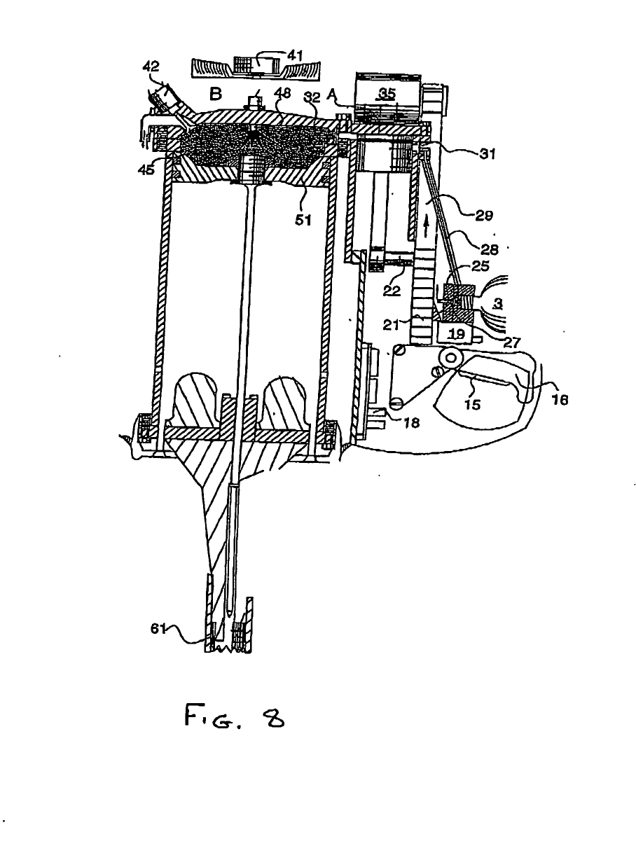

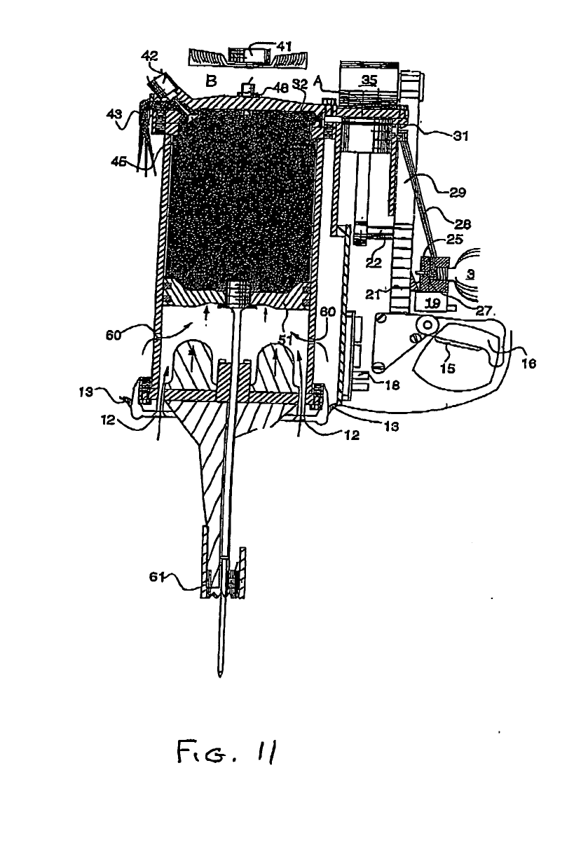

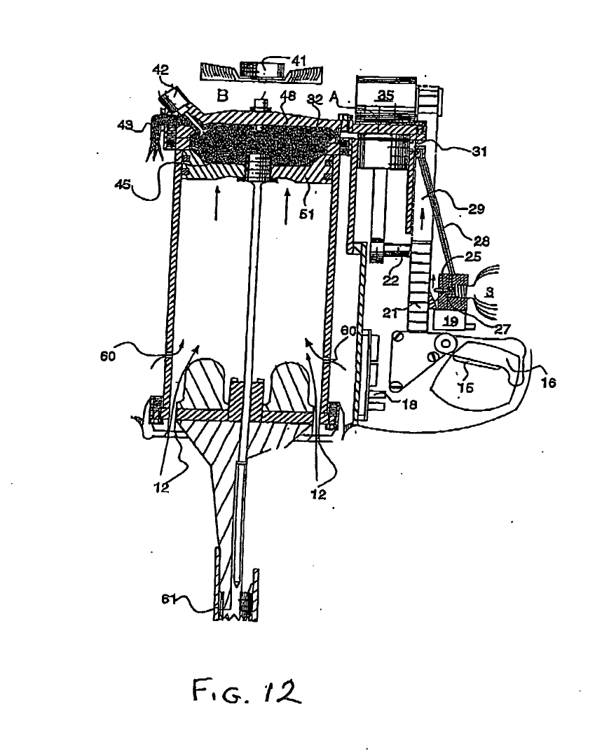

The operation of the combustion nail gun will now be described. A user holds the combustion driven nail gun by tool support handle 7 and pistol grip 5. The user's finger is placed on firing trigger 16. Primary micro trigger 15 is activated. Electronic central processing unit (CPU) 18 is alerted that the tool is in operation. CPU 18 switches circuit on to a priming cylinder drive having a cycle sensor wheel 21 and main power feed slip ring 66 as shown in FIG. 13. Motor 35 is activated. Wheel 21 rotates causing first piston 24 to progress downward in priming cylinder A via connecting rod 23, crank pin 22 and bearing 34. A partial vacuum occurs above piston 24 in priming cylinder A causing transfer valve 32 to close and intake valve 31 to open. Air is drawn into priming cylinder A through intake port 30. Fuel delivery striker segment 25 makes contact with pin 27 opening gas valve 26 in the head of gas cylinder 3 for a short duration. A given volume of atomised fuel is released from cylinder 3 and passes through gallery 28 to intake port 30. Atomised fuel gas mixes with inward flowing air at intake port 30 through valve 31, filling priming cylinder A with a mixture of fuel, gas and air, see FIG. 5. Piston 24 progresses back up priming cylinder A, and a pressure rise occurs closing valve 31, see FIG. 6, and opening valve 32 transferring air/fuel mixture from priming cylinder A into driving cylinder B. Electro magnetic exhaust valves 42 and 45 are energised during the upward progression of piston 24 causing valve head 45 to open, allowing the inward flow of fuel/gas air mixture through valve 32 to purge residual exhaust gases from combustion space in cylinder B, see FIG. 7. When 50% of the fuel/gas air mixture phase has taken place slip ring 67 disengages electro magnetic valve 42 causing valve head 45 to close via a coil spring (not shown) and sealing exhaust port 43. Piston 24 progresses to the top of priming cylinder A transferring fuel/gas air mixture into combustion area of driving cylinder B. Slip ring 69 disengages power circuit to motor. CPU 18 switches circuit on to cooling fan motor 41. Tool is positioned and pressed onto a work piece, mechanism 61 is depressed alerting CPU 18 tool is safe to fire. CPU 18 switches circuit on to switch mechanism 17 allowing main firing trigger 16 to be fully depressed. Mechanism 17 alerts CPU 18 to activate igniter 48. Fuel/air mixture in combustion area of driving cylinder B ignites and an explosion occurs, a rapid rise of pressure occurs causing valve 32 to seal close, see FIG. 8. Second piston 51 and driver 55 progress down bore 54 of cylinder B. Driver 55 drives fastener 8 down tool nose 9 into the work piece. As piston 51 progresses down cylinder B air under piston 51 escapes through exhaust port 60 and 12. When piston 51 has traveled 90% of its travel the under side of piston 51 comes into contact with rubber bumper 58. Bumper 58 absorbs energy and slows the progression of piston 51. Exhaust port 60 is then uncovered allowing exhaust gases to escape from cylinder B into cavity 57 and then out through tool housing exhaust port 13. At the end of travel piston 51, piston 51 makes contact with power driver cylinder piston end of stroke sensor 59. Sensor 59 alerts CPU 18 of the position of piston 51. CPU 18 energises electro magnetic exhaust valve 42 to open allowing exhaust gases to be expelled from the top of cylinder B through exhaust port 43 into cavity 57 and out through cavity 13. Stored energy in bumper 58 returns piston 51 and driver 55 back up bore 54 in driving cylinder B. Remaining exhaust gases in driving cylinder B are purged through exhaust port 43. Air is allowed to be displaced to the underside of piston 51 in cylinder B through exhaust port 60 and 12 to prevent a partial vacuum inhibiting the return of piston 51 to top of bore 54 in cylinder B, see FIGS. 11 and 12. CPU 18 has an electronic timing mechanism built-in to operate electro magnetic valve 42 and cooling fan 41. When piston 51 has reached the top of bore 54 of cylinder B, the CPU 18 switches the circuit to electro magnetic exhaust valve 42 off, allowing valve head 45 to close. CPU 18 allows cooling fan 41 to remain active for a period of approximately 10 seconds in one-shot use only, or for continuous application the cooling fan 41 may remain active. A temperature sensor (not shown) in cavity 57 in communication with CPU 18 may be incorporated.

FIG. 13 depicts a mechanical brake/limiting mechanism (not shown) to ensure that only one revolution of cycle wheel 21 per tool cycle is required.

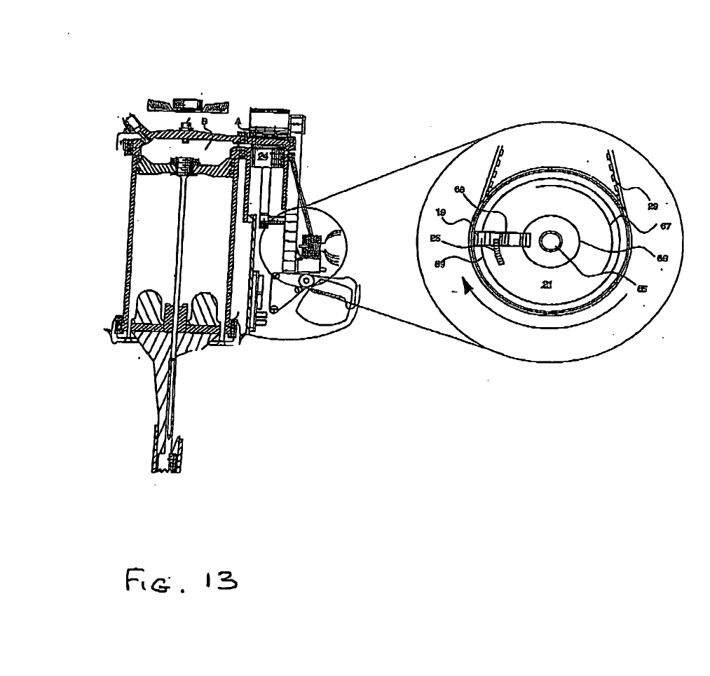

FIG. 14 is an alternate embodiment to the mechanical mechanism 21 of FIG. 13. In this alternate embodiment electronic crank angle mechanisms 70, 19a, stepper motor 35 and high-tension spark mechanisms maybe incorporated into and in communication with CPU 18.

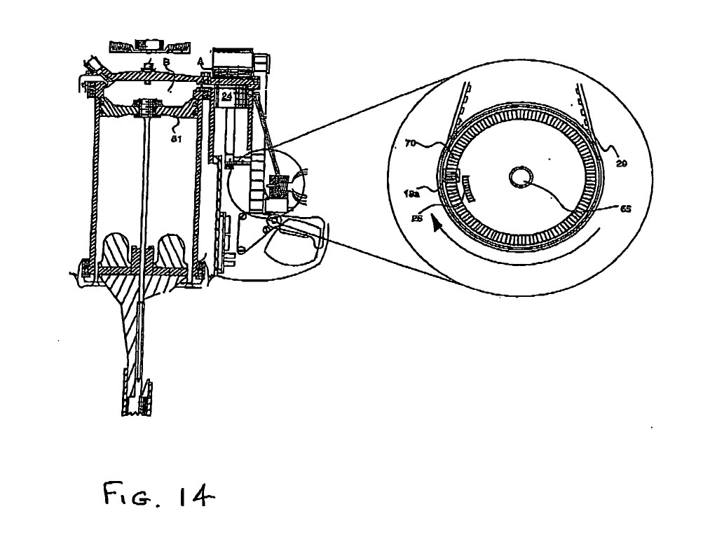

FIG. 15 depicts high pressure liquid fuel cylinders containing for example methanol as a fuel medium and liquid/gaseous CO₂ as a pressurizing medium as opposed to a conventional MAPP gas. Storing fuel in this matter typically at 850 psi allows more efficient atomization of the fuel gas medium and combining with air mass in a combustion cylinder process more energy is extracted. Hydrogen may also be utilised as a fuel gas medium.

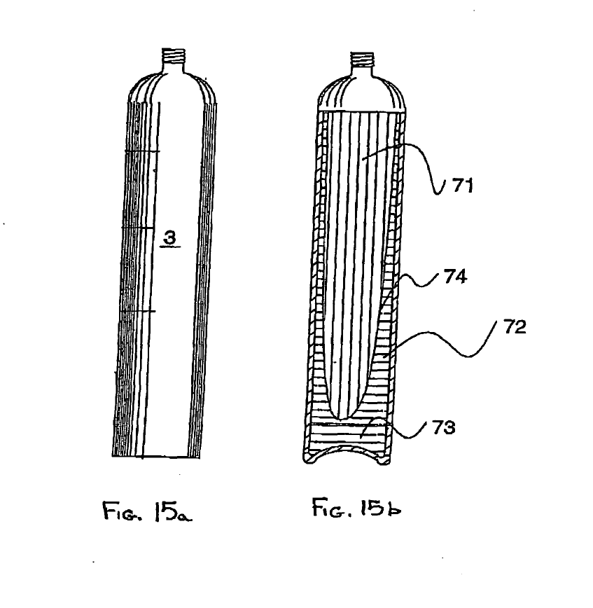

FIG. 16 depicts a second embodiment of a nail gun in accordance with the present invention. The nail gun of this second embodiment is similar to that of the first embodiment and like reference numerals have been used to depict similar components. The main difference is that the first embodiment shown in FIG. 2 has an actuation mechanism in the form of a connecting rod 23, crank pin 22 and bearing 34 for mechanically actuating the piston 24 within priming cylinder A. However, in this second embodiment the actuation mechanism is replaced by an electromagnetic actuation mechanism. A solenoid cylinder (or coil) 102 actuates piston 24 to transfer gas/fuel air mixture into driving cylinder B. A piston return spring 103 is connected to piston 24 to urge the piston upwardly when solenoid cylinder 102 is deactivated. Furthermore, gas release solenoid 104 replaces the mechanical means (of the first embodiment) of fuel delivery to intake port 30. The priming cylinder A also has exhaust ports 105. Solenoids 102 and 104 are both in communication with CPU 18 and are both electronically actuated.

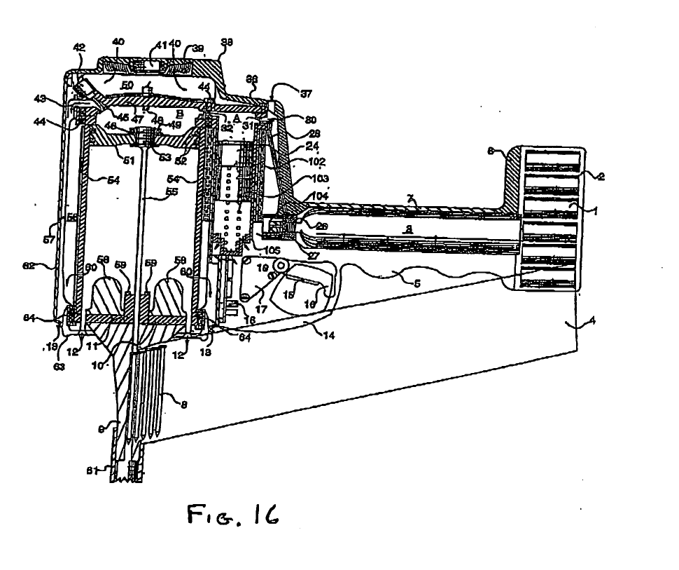

FIG. 17 depicts a third embodiment of a nail gun in accordance with the present invention. This embodiment is similar to that of the previous embodiments and like reference numerals have been used to denote similar components. This embodiment shows a number of preferable features, each of which may replace or compliment corresponding components of the previous embodiments. The preferable features are described individually in the following paragraphs.

The nail gun depicted in FIG. 17 comprises first and second spring biased balls 201 and 202 that are disposed on mechanism 61 and engage the bottom of driver 55 to retain second piston 51 near the top of driving cylinder B. Balls 201 and 202 move inwardly towards each other by spring force, once driver 55 passes above them on the return stroke of the tool. In alternative arrangements, balls 201 and 202 engage location indentations in driver 55, which advantageously provides positive control of driver 55. In use, balls 201 and 202 retain second piston 51 and driver 55 high in driving cylinder B, even as the compressed fuel/air gas mixture is introduced. When the tool is subsequently positioned and pressed onto the work piece, mechanism 61 is depressed from a first to a second position, alerting CPU 18 that the tool is safe to fire. As mechanism 61 is depressed, second piston 51 also moves higher, further compressing the air/fuel gas mixture in driving cylinder B just prior to ignition. Upon ignition, second piston 51 and driver 55 are forcibly driven down, overcoming the spring force of first and second spring biased ball 201 and 202. When second piston 51 and driver 55 complete their return stroke, first and second spring biased balls 201 and 202 again engage the bottom of driver 55. This arrangement enables high pre-ignition gas pressures to be achieved due to the extra 10% or so of upward travel imparted to second piston 51.

The third embodiment of the nail gun depicted in FIG. 17 depicts a chamber 203 that exists in the interior of bumper 58. Bumper 58 is preferably constructed of high-grade durable rubber and layered fabric to provide durability and high resilience. In this configuration, bumper 58 still slows the progression of piston 51 and then returns piston 51 and driver 55 back up bore 54 in driving cylinder B. For those purposes, a spring may also supplement bumper 58. In use, as bumper 58 is compressed by piston 51, chamber 203 compresses, sending pressurised air out outlet valve 204, through transfer channel 205 and into internal receiver 206 of piston 24. Bumper 58 and chamber 203 resiliently restore from their compressed state, forcibly returning piston 51 back up bore 54. The expanding volume of chamber 203 causes a pressure drop that closes outlet valve 204 and opens fill valve 209, drawing fresh air into chamber 203 while sealing transfer channel 205 at pressure. In this way, wasted energy is recovered by pumping pressurised air back to priming cylinder A for subsequent use. The pressure of the air/fuel mixture is also increased, which in turn increases the efficiency of its combustion.

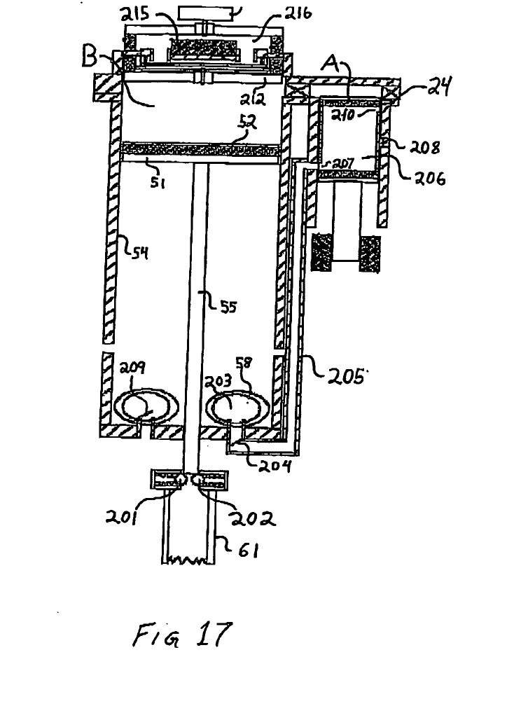

FIG. 18 will now be used to describe how piston 24 and internal receiver 206 interact to utilise the air pressurised by chamber 203. The motion of piston 24 occurs as explained in the previous embodiments. Whenever piston 24 is at the top of priming cylinder A, inlet aperture 207 is aligned with transfer channel 205. Piston 24 is in this top position when the downward motion of piston 51 compresses bumper 58 and thus pressurises the air in transfer channel 205 through to internal receiver 206. As explained above, when piston 51 returns up bore 54, outlet valve 204 closes, keeping transfer channel 205 and internal receiver 206 pressurised. Upon the next use, piston 24 travels downward, sealing internal receiver 206. The same downward motion simultaneously creates a partial vacuum above piston 24 in priming cylinder A, causing transfer valve 32 to close and intake valve 31 to open. Air and fuel are drawn into priming cylinder A through intake port 30 and valve 31. When piston 24 nears the bottom of its travel, bypass 208 aligns with bypass aperture 210 allowing pressurised air from internal receiver 206 to pressurise the air/fuel mixture above piston 24. The consequential pressure rise closes intake valve 31. Piston 24 then progresses back up priming cylinder A and a further pressure rise occurs, opening valve 32 and transferring the air/fuel mixture from priming cylinder A into driving cylinder B. This arrangement advantageously allows the pressurised air from chamber 203 to be stored for use at a later time.

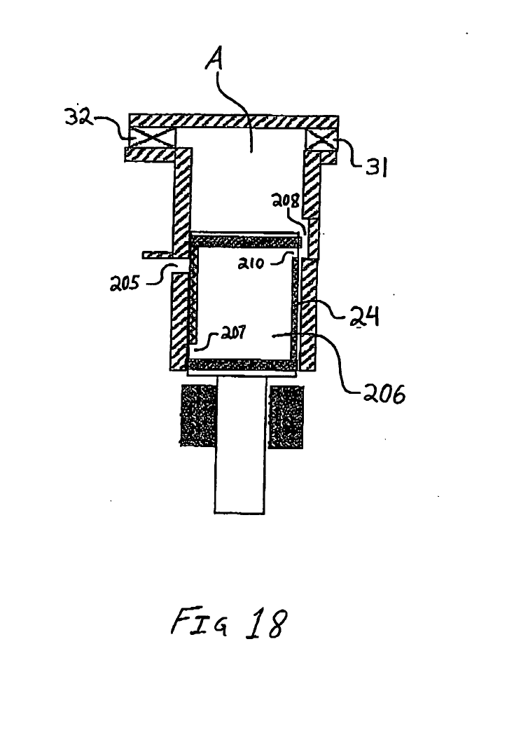

FIG. 19 is an enlarged partial view of second piston 51 depicting a preferable configuration of sealing ring 52. In this configuration, sealing ring 52 is fabricated from carbon impregnated Teflon and has the cross-sectional shape shown in FIG. 19. The material of sealing ring 52 and its small contact area with bore 54 results in minimal frictional resistance, which advantageously results in a smaller upward force required to return second piston 51 back up driving cylinder B. A semi flexible lip 211 extends upward from sealing ring 52 and is spaced apart from bore 54 when lip 211 is at rest. Upon ignition, high pressure acts on the top of second piston 51 and sealing ring 52, causing lip 211 to flex outward against bore 54 from its rest position, thereby providing a greater gas seal and minimising losses. Once the gas pressure is relieved, the sealing lip 211 returns to its rest position off of bore 54 thus minimising resistance during the return stroke.

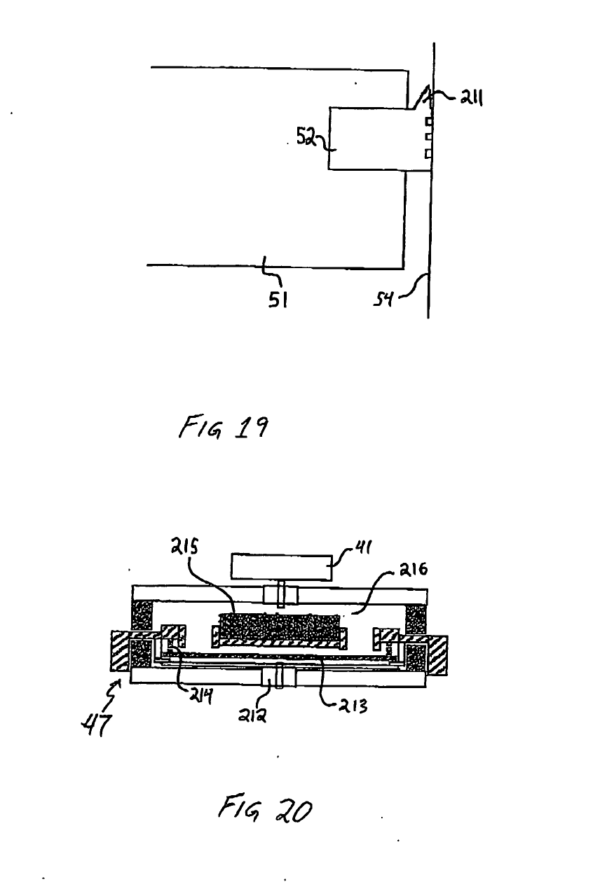

FIG. 20 is an enlarged schematic view of a preferable alternative configuration of power driver cylinder head 47. In this configuration, mixing fan 212 is rotatably mounted to the interior of power driving cylinder B. Mixing fan 212 is magnetically coupled to cooling fan motor 41, which is mounted to the exterior of driving cylinder B. Structural components between mixing fan 212 and cooling fan motor 41 are preferably made of aluminium. Mixing fan 212 agitates the air/fuel gas mixtures to obtain more complete combustion, raising the reliability of the tool's power output.

FIG. 20 also depicts electro magnetic valve 42 being replaced by plate valve 213, which is preferably also electro magnetically actuated. When plate valve coil 215 is de-energised, plate valve spring 214 biases plate valve 213 to the open position. When CPU 18 energises plate valve coil 215, electro magnetic force overcomes plate valve spring 214 to close plate valve 213. When plate valve 213 is open, power driving cylinder B is in fluid communication with exhaust plenum 216, allowing rapid purging of residual exhaust gases from the combustion space in cylinder B.

Whilst the abovementioned embodiment of the present invention is described with reference to a nail gun for driving nails, it should be understood that the present invention in other not shown embodiments can be used to fire other fasteners, but is limited thereto. Also, in other not shown embodiments the gas combustion mechanism of the abovementioned embodiment may be used in some other apparatus where an object is propelled. Such drive apparatus may have a tool or drive application different to the nail gun of the abovementioned embodiments.

The term “comprising” (and its grammatical variations) as used herein is used in the inclusive sense of “having” or “including” and not in the exclusive sense of “consisting only of”.

I claim:

1. A fastener driving tool comprising: a tool nose through which a fastener is fired; a loading apparatus for introducing said fastener into said tool nose; said fastener being propellable by a gas combustion mechanism, wherein said gas combustion mechanism comprises a first priming cylinder having a first piston, an air intake and a first valve apparatus for fluidically connecting said air intake to a second delivery cylinder having a second piston, said first priming cylinder fluidically connected to a fuel gas reservoir via a second valve apparatus, wherein said first priming cylinder receives fuel gas from said fuel gas reservoir and air through said air intake to form an air/fuel gas mixture therein, wherein said first piston compresses said air/fuel gas mixture and transfers said air/fuel gas mixture to said second delivery cylinder via said first valve apparatus, and wherein said air/fuel mixture is ignited therein and urges said second piston towards said fastener and propels said fastener away from said tool nose.

2. The fastener driving tool as claimed in claim 1, wherein said first piston is mechanically actuated.

3. The fastener driving tool as claimed in claim 1, wherein said second valve apparatus is opened and closed via mechanical actuation.

4. The fastener driving tool as claimed in claim 1, wherein said first piston is electromagnetically actuated.

5. The fastener driving tool as claimed in claim 1, wherein said second valve apparatus is opened and closed via electromagnetic actuation.

6. The fastener driving tool as claimed in claim 1, wherein said fastener driving tool is a nail gun.

7. The fastener driving tool as claimed in claim 1, wherein a mechanism movable between a first and a second position along said tool nose includes a latching apparatus for engaging said second position, such that said air/fuel gas mixture is further compressed by said second piston as said mechanism is moved from said first to said second position with said latching apparatus engaged and wherein the downward force from the ignition of said air/fuel mixture overcomes said latching apparatus and urges said second piston towards said fastener.

8. The fastener driving tool as claimed in claim 1, wherein a bumper is disposed near the bottom of said second delivery cylinder, said bumper being compressible by said second piston in the bottom of the travel of said second piston and wherein the subsequent restoration of said bumper forcibly returns said second piston back up said second delivery cylinder.

9. The fastener driving tool as claimed in claim 8, wherein the interior of said bumper forms a chamber for porting pressurised air via an outlet valve through a transfer channel to said first priming cylinder as said bumper is compressed.

10. The fastener driving tool as claimed in claim 9, wherein said first piston has an internal receiver for storing said pressurised air.

11. The fastener driving tool as claimed in claim 1, further comprising a sealing ring having a semi-flexible lip and being disposed around the periphery of said second piston.

12. The fastener driving tool as claimed in claim 1, wherein a mixing fan is rotatably mounted to the interior of said second delivery cylinder.

13. The fastener driving tool as claimed in claim 12, wherein an externally mounted motor drives said mixing fan via magnetic coupling.

14. The fastener driving tool as claimed in claim 1, further comprising a plate valve and an exhaust plenum, wherein said plate valve fluidly connects said second delivery cylinder with said exhaust plenum when said plate valve is opened for exhausting said second delivery cylinder.

15. An apparatus utilising a gas combustion mechanism for propulsion of an object, said gas combustion mechanism comprising a first priming cylinder having a first piston and an air intake fluidically connected via a first valve apparatus to a second delivery cylinder having a second piston, said first priming cylinder fluidically connected to a fuel gas reservoir via a second valve apparatus, wherein said first priming cylinder receives fuel gas from said fuel gas reservoir and air through said air intake to form an air/fuel gas mixture therein, wherein said first piston compresses said air/fuel gas mixture and transfers said air/fuel gas mixture to said second delivery cylinder via said first valve apparatus, and wherein said air/fuel mixture is ignited therein and urges said second piston towards said object to propel said object.
